(19) United States
(12) Patent Application Publication
(10) Pub. No.: US 2025/0162241 A1
(43) Pub. Date: May 22, 2025

(54) System and Method of Membrane Release in Resin 3D Printing

(71) Applicant: BMF Nano Material Technology Co., Ltd., Shenzhen (CN)

(72) Inventors: Liangkang Fu, Shenzhen (CN); Chen Yang, Shenzhen (CN); Xiao Ding, Shenzhen (CN); Chunguang Xia, San Diego, CA (US)

(73) Assignee: BMF Nano Material Technology Co., Ltd., Shenzhen (CN)

(21) Appl. No.: 18/840,447

(22) PCT Filed: Feb. 22, 2023
(86) PCT No.: PCT/IB2023/051584

§ 371 Date: Aug. 21, 2024

Related U.S. Application Data
(60) Provisional application No. 63/313,163, filed on Feb. 23, 2022.

(51) Int. Cl. B29C 64/129; B29C 64/232; B29C 64/241; B29C 64/245; B29C 64/264; B33Y 10/00; B33Y 30/00

(52) U.S. Cl. CPC B29C 64/129; B29C 64/232; B29C 64/241; B29C 64/245; B29C 64/264; B33Y 10/00; B33Y 30/00

(57) ABSTRACT

A 3D printing system and method for mitigating the force needed to separate a transparent printing membrane from a most-recently photocured layer of resin on a sample secured to a platform. The membrane is coupled to an actuator and a pivot joint adapted to rotate the membrane into the resin, and the platform is coupled to a vertical stage adapted to translate the platform downward. Through simultaneous activation of the actuator and the vertical stage, the membrane is progressively peeled away from the sample. The system and method are suitable for various membrane-based 3D printing technologies including large-area projection micro stereolithography (PμSL).

### FIELD

The present disclosure relates to additive manufacturing, and more particularly, to systems and methods for mitigating the force needed to separate a printing sample from a transparent membrane during high-resolution 3-D printing over a large area.

### BACKGROUND

Stereolithography was originally conceived as a rapid prototyping technology used to create true-scale models of production components directly from computer aided design (CAD) in a rapid (faster than before) manner. Since its conception, and through its disclosure in U.S. Pat. No. 4,575,330, stereolithography has greatly aided engineers and designers in visualizing complex three-dimensional part geometries, detecting errors in prototype schematics, testing critical components, and verifying theoretical designs at relatively low costs and improved time frames.

During the past decades, continuous improvements in the field of micro-electromechanical systems (MEMS) have led to the emergence of micro-stereolithography (μSL), which inherits basic principles from traditional stereolithography but with much higher spatial resolution. See, e.g., Ikuta et al., “Real three dimensional micro fabrication using stereo lithography and metal molding,” Proceedings of MEMS '93, 6th IEEE Workshop on Micro Electro Mechanical Systems, San Diego, CA, Jan. 25-28, 1993, pp. 42-47.

The resolution of μSL was improved with the development of single-photon polymerization and two-photon polymerization techniques to achieve printed features of less than 200 nm. See, e.g., Maruo et al., “Three-dimensional microfabrication by use of single-photon-absorbed polymerization,” Applied Physics Letters 76(19):2656-2658, 2000; Maruo et al., “Two-photon-absorbed near-infrared photopolymerization for three-dimensional microfabrication,” Journal of Microelectromechanical Systems 7(4):411-415, 1998; and Kawata et al., “Finer features for functional microdevices—micromachines can be created with higher resolution using two-photon absorption” Nature 412(6848):697-698, 2001.

The speed of μSL was dramatically increased with the development of projection micro-stereolithography (PμSL). See, e.g., Bertsch et al., “Microstereolithography using liquid crystal display as dynamic mask-generator,” Microsystem Technologies, 3(2):42-47, 1997; and Beluze et al., “Microstereolithography: A New Process to Build Complex 3D Objections, Symposium on Design, Test and Microfabrication of MEMs/MOEMs,” Proceedings of SPIE 3680(2):808-817, 1999. The core of this technology is a high resolution spatial light modulator, which is either a liquid crystal display (LCD) panel or a digital light processing (DLP) panel, each of which are available from micro-display industries. While PμSL technology has been successful in delivering fast fabrication speed with good resolution, further improvements are still needed.

During PμSL printing, a resin layer is defined between a vat (or reservoir) of resin and the sample stage. A “sample” may refer to the 3-D model as it is being printed layer by layer, and a “sample stage” may refer to the most recently printed layer of the sample. There are at least three methods for defining the resin layer in PμSL. A first method uses a free surface where the layer thickness is defined by a distance between the resin's free surface and a sample stage. However, with this method it may take more than a half an hour to define a 10 μm thick resin layer having a viscosity of 50 cP over a 1 cm by 1 cm area. One reason for slow printing is because of the slow viscous motion of resins. Second and third methods for defining the resin layer in PμSL use a transparent membrane or a hard window, respectively.

The materials of the membrane or window (hereafter simply referred to as a membrane) may be impermeable to gas, such as Teflon perfluoroalkoxy (PFA) or Teflon fluorinated ethylene propylene (FEP), or the materials may be permeable to gas (specifically permeable to oxygen), such as polydimethylsiloxane (PDMS) or Teflon amorphous polymers (AF). Gas permeability may be desired to reduce the adhesion between the membrane and the printing part. This is because oxygen permeating through the membrane may create a photo polymerization inhibition layer, or “dead zone,” that may result in a residual layer of liquid between the membrane and the printing part. As gas permeability of the membrane increases, the adhesion between the membrane and the printing part decreases.

Unfortunately, the thickness of the inhibition layer, which is generally 10-50 μm, may create significant dimensional error in precision 3D printing, where tolerance requirements may be similar to, or even less than, the thickness of the inhibition layer. Therefore, in many precision 3D printing applications, a zero-thickness or ultra-thin oxygen inhibition layer is preferred. As a result, excessive adhesion between the membrane and the printing part is unavoidable.

The disclosed embodiments solve several of the above-described problems and other problems in the prior art. Specifically, the embodiments disclose a rotational membrane-releasing mechanism to separate the membrane from the printing part through a “peeling” action, overcoming excessive membrane-to-part adhesion of a normal pulling action and thereby increasing the success rate of 3D printing.

### SUMMARY

The several embodiments provide for a reliable method of separating a printing part from a membrane during a 3D printing process. This method is well suited for PμSL, and is also valid for other 3D printing methods that utilize a membrane to assist 3D printing.

In either PμSL or SLA, a solid layer is created, i.e., printed, by photopolymerizing liquid printing material(s) between a membrane and a printing platform or a last cured layer of resin. By stacking such layers in a vertical (z) direction, a physical 3D model may be created. Common printing materials used in industry are liquid photocurable resins or slurries (resins mixed with solid particles). Hereafter the term resin may describe a resin, slurry, or any other liquid or gelatinous photocurable printing material. Herein the term solid describes the solid phase of matter, where a solid printing layer or sample may be rigid or elastomeric (i.e., compressible).

A gap between a membrane and a printing platform or a last cured layer of resin defines a thickness of the next layer to be cured, i.e., printed. Projecting ultraviolet (UV) light onto (or into) the resin within the gap causes that layer of resin to cure, where curing is a process of solidifying the liquid resin. To print a subsequent layer k+1 on top of a last cured layer k, it is critical that the adhesion between the membrane and the last cured layer k, i.e., the “membrane adhesion,” be less than the adhesion between the last cured layer k and the previously cured layer k−1. Indeed, to prevent delamination of cured layers, the membrane adhesion must be less than the adhesion between any contacting layers k and k−1, and it must also be less than the adhesion between the first cured layer k=1 and the printing platform.

Printing failure is said to occur when delamination occurs. Printing failure may be avoided or reduced by lowering the membrane adhesion, i.e., the force required to separate the membrane from the last cured layer of resin. The several embodiments of this disclosure provide a system and method for lowering membrane adhesion by separating the membrane from the last cured layer of resin via a “peeling” motion. Existing membrane-based 3D printing systems utilize a pulling motion to separate the membrane from the last cured layer. The pulling motion is normal (perpendicular) to the surface of the last cured layer.

The force required to separate a membrane from a printed layer via a normal pulling motion can be described using the Stefon equation. This equation describes the viscous adhesion between two parallel circular plates sandwiching a layer of viscous fluid, which is similar to the situation during separation of a membrane and a last cured layer. The Stefon equation can be written as:

$$F = \frac{3 πη {r}^{4}}{2 {h}^{3}} \frac{dh}{dt} ,$$

where i is the dynamic viscosity of the viscous fluid, r is the radius of plates, and h is the distance between plates. The adhesive stress a of a body, which tends to deform the body, is the force F per unit area r², as written below:

$$σ = \frac{F}{{r}^{2}} = \frac{3 πη {r}^{2}}{2 {h}^{3}} \frac{dh}{dt} .$$

The above equations reveal that the radius r (or area r²) of the plates significantly affects the adhesion force and the adhesive stress. Because the conventional pulling method separates a membrane from a last cured layer practically instantaneously along the entire membrane-layer contact area, the required force and resulting stress may be excessive. However, using the peeling method described herein, separation of a membrane from a last cured layer proceeds gradually along a leading edge of a peeling direction. Because the peeling method reduces the membrane-layer contact area to only the leading edge of the peeling direction, the required force and resulting stress may be significantly reduced as compared to the pulling method.

Some embodiments comprise a light engine which may be coupled to a light source and a lens, and may be adapted to project a first image received from a computer onto a first layer of photocurable resin to create a first cured layer therefrom. The photocurable resin may be sandwiched between a lower surface of a transparent membrane and an upper surface of a printing sample (or an upper surface of a platform when a 3D printing process begins). The membrane may be coupled to an actuator and a pivot joint. The printing sample may be secured to a platform which may be coupled to a vertical stage. The actuator and the vertical stage may be adapted for a simultaneous first operation comprising a first activation of the actuator and a first activation of the vertical stage. The first activation of the actuator may rotate a portion of the membrane downward D-degrees about the pivot joint. The first activation of the vertical stage may translate the platform downward. The simultaneous first operation may proceed until none of the membrane contacts the first photocured layer.

In some embodiments the actuator and the vertical stage may be further adapted for a second operation comprising a second activation of the actuator and a second activation of the vertical stage. The second activation of the actuator may rotate the portion of the membrane D-degrees upward. The second activation of the vertical stage may translate the platform upward.

In some embodiments the light engine coupled to the light source and the lens may be adapted to project a second image received from the computer onto a second layer of photocurable resin sandwiched between the lower surface of the membrane and an upper surface of the first cured layer to create a second cured layer therefrom.

Some embodiments may comprise a second vertical stage adapted to translate a vat, in which the resin is stored, and to which the actuator and the pivot joint are attached, upward or downward. Such translation may accommodate a varying depth of resin within the vat and/or place the wet surface (bottom surface) of the membrane at the focal plane of the optics.

In some embodiments the membrane may comprise an upward-extending rim circumscribing a top surface thereof.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 shows a schematic of a PμSL system having a rotational membrane-releasing mechanism.

FIG. 2 shows an embodiment of a rotational portion of a rotational membrane-releasing mechanism.

FIGS. 3A-3B illustrate the working principle of a rotational membrane-releasing mechanism.

FIGS. 4A-4D illustrate a printing sequence for a PμSL system having a rotational membrane-releasing mechanism.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure. For example, “left,” “right,” “clockwise,” and “counterclockwise” may be used as specific examples of generally opposite lateral or rotational directions, respectively. Also, as used in the specification and including the appended claims, the singular forms “a,” “an,” and “the” include the plural, and reference to a particular numerical value includes at least that particular value, unless the context clearly dictates otherwise.

The following numerals are used to describe various features of the embodiments.
10 3D printing system
20 computer
30 light engine
40 lens
50 sample
100 membrane
110 membrane clamp
120 pivot joint
200 actuator
210 platform
300 vat
310 resin
400 X-Y precision stages
410 platform vertical stage
420 membrane vertical stage

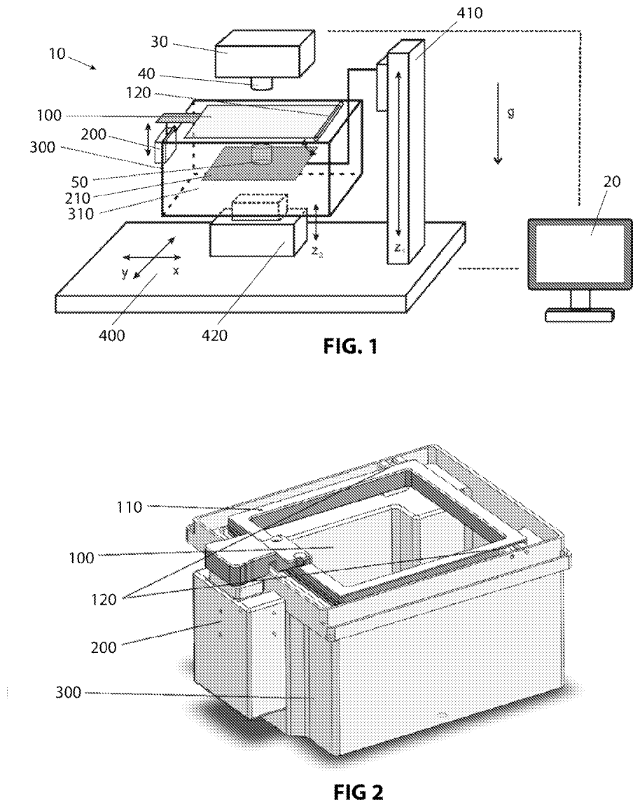

FIG. 1 shows an embodiment of a 3D printing system 10 comprising a computer 20 adapted to transmit images to a light engine 30. Exemplary light engines 30 may include a digital light processing (DLP) chip or a liquid crystal display (LCD) coupled to a light-emitting diode (LED) light source in the case of projection micro-stereolithography (PμSL), or a laser beam with steering mirrors in the case of stereolithography (SLA). The light engine 30 is coupled to a lens 40 that defines a magnification of pixel size and focuses light onto a printing surface.

X-Y precision stages 400 control relative lateral motion between the projected images (from the light engine 30 and the lens 40) and a printing platform 210 on which a printing sample 50 may be printed. A vat 300 contains resin 310. Near a top surface of the resin 310 is a transparent membrane 100. The membrane 100 is commonly made of perfluoroalkoxy (PFA) or fluorinated ethylene propylene (FEP) and usually has a thickness of 50-100 μm.

The membrane 100 is coupled to an actuator 200 at a first location (at a left end of the membrane 100 in FIG. 1). The actuator 200 is mounted on the vat 300. The membrane 100 is coupled to a pivot joint 120 at a second location (at a right end of the membrane 100 in FIG. 1). The pivot joint 120 is mounted on the vat 300. Thus, actuation (activation) of the actuator 200 causes the membrane 100 to rotate about the pivot joint 120, either downward into the resin (counterclockwise) or upward (clockwise).

A platform vertical stage 410 controls a height of the platform 210 on which the sample 50 is printed. Each layer of the sample 50 is created by photocuring a layer of resin 310 immediately beneath the membrane 100. The sample 50 is therefore secured to the platform 210 by adhesion of a first printed layer, and subsequent layers are printed one on top of the other. A membrane vertical stage 420 controls a height of the vat 300 and the membrane 100 attached thereto, which may accommodate varying depth of resin 310 within the vat 300 and/or place the wet surface (bottom surface) of the membrane at the focal plane of the optics.

FIG. 2 shows an embodiment of a rotational portion of a rotational membrane-releasing mechanism comprising the membrane 100, the pivot joint 120, and the actuator 200. The pivot joint 120 and actuator 200 are mounted on the vat 300. The membrane 100 is secured to a membrane clamp 110, which is in turn coupled to the pivot joint 120 and the actuator 200. Thus, actuation of the actuator 200 causes the membrane clamp 110, and therefore the membrane 100, to rotate about the pivot joint 120. The actuator 200 may be any suitable mechanism that creates motion, such as a rotational motor or a linear stage.

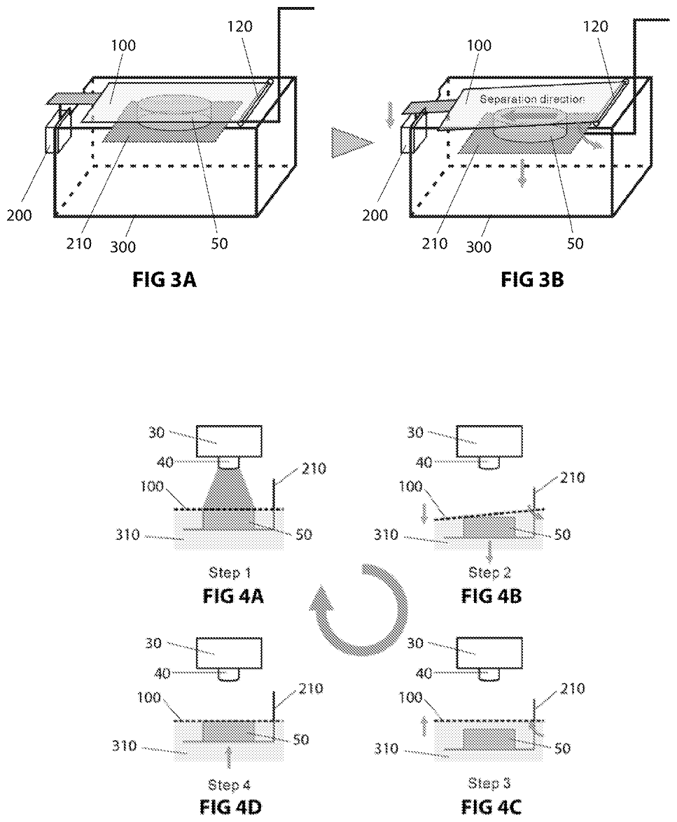

FIGS. 3A-3B illustrate the working principle of a rotational membrane-releasing mechanism. In FIG. 3A, a new layer of resin 310 has just been photocured between a lower surface of the membrane 100 and an upper surface of the sample 50 (i.e., the “wet” surface of the membrane 100). At this point, the newly photocured layer has become a new layer of the sample 50. However, the newly photocured layer (now considered a topmost layer of the sample 50) is also adhered to the membrane 100. To be able to add more layers to the sample 50, the membrane 100 must first be separated from the sample 50. The rotational membrane-releasing mechanism performs this separation by peeling the membrane 100 away from the sample 50 as described below.

The actuator 200 is activated to pull the left side of the membrane 100 downward into the resin 310, i.e., counterclockwise, about the pivot joint 120 through a small angle of approximately 2-5 degrees. Rotating a portion of the membrane 100 into the resin 310, instead of away from the resin 310, is preferred to avoid introducing air beneath the membrane 100 and potentially causing problematic air bubbles during the printing of a subsequent layer. At the same time that the actuator 200 rotates the membrane 100, the platform vertical stage 410 translates the entire platform 210 downward. This simultaneous rotational and translational motion causes the membrane 100 to peel away from the sample 50, beginning on the right end of the membrane 100 and proceeding to the left end of the membrane 100. The rotational and translational motion may continue until the membrane 100 is completely separated from the sample 50, i.e., until none of the membrane 100 contacts the sample 50.

For best results, the speed at which the actuator 200 rotates the membrane 100, and the speed at which the platform vertical stage 410 descends the platform 210 should be appropriately balanced. These speeds may depend on several factors, including the material of the membrane 100, the surface area of the membrane 100, the surface area of each layer of a sample 50, the size of the vat 300, the locations of the actuator 200 and pivot joint 120, and the type of resin 310. For a typical 3D printer adapted to include a rotational membrane-releasing mechanism as shown in FIGS. 1-3, the actuator 200 may cause the left end of the membrane 100 to descend at a speed of 1-3 mm/s, and the platform vertical stage may cause the platform to descend at a rate of 1-3 mm/s.

FIGS. 4A-4D illustrate a complete cycle for printing one layer in a PμSL system having a rotational membrane-releasing mechanism. Each layer corresponds to a 2D image that is created by discretizing, or slicing, a 3D computer-aided design (CAD) model of the part to be printed into a sequence of cross-sectional images. The number of cross-sectional images per unit length, and therefore the number of layers per unit length, depends on several factors, including a desired vertical resolution of the printed part, the resolution capabilities of the chosen 3D printing technology, and the type of resin(s) used. Common layer thicknesses are in the range of 5-20 μm.

To print a layer, a computer 20 (not shown in FIGS. 4A-4D) sends the image corresponding to that layer to a light engine 30. As shown in FIG. 4A, ultraviolet (UV) light from a light source coupled to or integrated with the light engine 30 is modulated by the light engine 30 and then projected and focused by a lens 40 onto a layer of photocurable resin 310 adjacent to a lower surface of a membrane 100. The projected and focused modulated UV light appears as a pattern of bright and dark regions in accordance with the image sent by the computer 20. The bright regions cause the photocurable resin 310 to cure, or polymerize, thereby transitioning from a liquid to a solid. The photocurable resin 310 remains liquid at the dark regions. At this point a new layer has been added to the sample 50; however, that layer may be adhered to the lower surface of the membrane 100.

In FIG. 4B, the actuator 200 has been activated to cause the membrane 100 to rotate counterclockwise into the resin 310. At the same time, the platform vertical stage 410 has been activated to cause the platform 210 to translate downward. This simultaneous motion continues until the entire membrane 100 has been peeled away from the sample 50. Note that the rotational membrane-releasing mechanism may be adapted to prevent any resin 310 from flowing around and on top of the membrane 100 during the peeling process. For example, the membrane clamp 110 may include a vertical barrier that circumscribes the entire membrane 100 (like a bowl) to prevent an inflow of resin 310 during rotation. Additionally or alternatively, the angle through which the membrane rotates may be minimized to prevent an inflow or resin 310 during rotation.

In FIG. 4C, the actuator 200 has been activated a second time, causing the membrane 100 to rotate clockwise and thereby returning to an initial printing position.

Finally, in FIG. 4D, the platform vertical stage 410 has been activated a second time, causing the platform 210 to translate upward toward the membrane 100 and thereby returning to an appropriate height for the printing of a next layer. Note that the second activation of the actuator 200 and the second activation of the platform vertical stage 410 may occur sequentially, as described above, or simultaneously. In some instances, the membrane 100 may deform during rotation due to tension forces. Therefore, before printing the next layer, a delay and/or use of a technology such as the roller coating technology from Boston Micro Fabrication might be required to allow the membrane 100 to flatten out.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

1. A method of printing a 3-D sample, comprising:
projecting a first image, received by a light engine coupled to a light source and a lens from a computer, to create a first photocured layer from photocurable resin sandwiched between a lower surface of a transparent membrane, coupled to an actuator and a pivot joint, and an upper surface of a printing sample secured to a platform coupled to a first vertical stage; and then
rotating, by the actuator, a portion of the membrane Φ-degrees downward about the pivot joint, while simultaneously translating, by the first vertical stage, the platform downward; until none of the membrane contacts the first photocured layer.

2. The method of claim 1 further comprising:
rotating, by the actuator, the portion of the membrane Φ-degrees upward; and
translating, by the first vertical stage, the platform upward.

3. The method of claim 2 further comprising projecting a second image received by the light engine from the computer to create a second photocured layer from photocurable resin sandwiched between the lower surface of the membrane and an upper surface of the first photocured layer.

4. The method of claim 3 further comprising vertically positioning the membrane relative to a focal plane of the light engine by translating a vat, in which the resin is stored and to which the actuator and the pivot joint are attached, upward or downward by a second vertical stage.

5. The method of claim 4 wherein the membrane comprises an upward-extending rim circumscribing a top surface thereof.

6. A 3-D printing system, comprising:
a light engine coupled to a light source and a lens adapted to project a first image received from a computer onto a first layer of photocurable resin sandwiched between a lower surface of a transparent membrane, coupled to an actuator and a pivot joint, and an upper surface of a printing sample secured to a platform coupled to a first vertical stage to create a first photocured layer therefrom; wherein
the actuator and the first vertical stage are adapted for a simultaneous first operation, comprising:
a first activation of the actuator that rotates a portion of the membrane downward Φ-degrees about the pivot joint, and
a first activation of the first vertical stage that translates the platform downward, until none of the membrane contacts the first photocured layer.

7. The system of claim 6 wherein the actuator and the first vertical stage are further adapted for a second operation, comprising:
a second activation of the actuator that rotates the portion of the membrane Φ-degrees upward, and
a second activation of the first vertical stage that translates the platform upward.

8. The system of claim 7 wherein the light engine coupled to the light source and the lens is adapted to project a second image received from the computer onto a second layer of photocurable resin sandwiched between the lower surface of the membrane and an upper surface of the first photocured layer to create a second photocured layer therefrom.

9. The system of claim 8 further comprising a second vertical stage adapted to translate a vat, in which the resin is stored and to which the actuator and the pivot joint are attached, upward or downward relative to a focal plane of the lens.

10. The system of claim 9 wherein the membrane comprises an upward-extending rim circumscribing a top surface thereof.
